(19) United States
(12) Patent Application Publication
(10) Pub. No.: US 2015/0061574 A1
(43) Pub. Date: Mar. 5, 2015

(54) CHARGER

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: SHEN-KANG LI, Shenzhen (CN); WEN-HUA CHEN, Shenzhen (CN)

(21) Appl. No.: 14/469,858

(22) Filed: Aug. 27, 2014

(30) Foreign Application Priority Data
Aug. 29, 2013 (CN) 2013103840016

(51) Int. Cl. H02J 7/00

(52) U.S. Cl. CPC H02J 7/0045; H02J 7/0013; H02J 7/0052; H02J 7/007; H02J 2007/0001
USPC 320/107

(57) ABSTRACT

A charger for charging a first device and a second device includes a current output unit, a switching unit, an identification unit, and a control unit. The identification unit identifies the first device and the second device, and outputs identification signals accordingly. The control unit is coupled to the current output unit, the switching unit, and the identification unit. The control unit controls the current output unit to output a first charging current or a second charging current according to the identification signals, and controls the switching unit to establish a first current path or a second current path between the current output unit and the first device according to the identification signals.

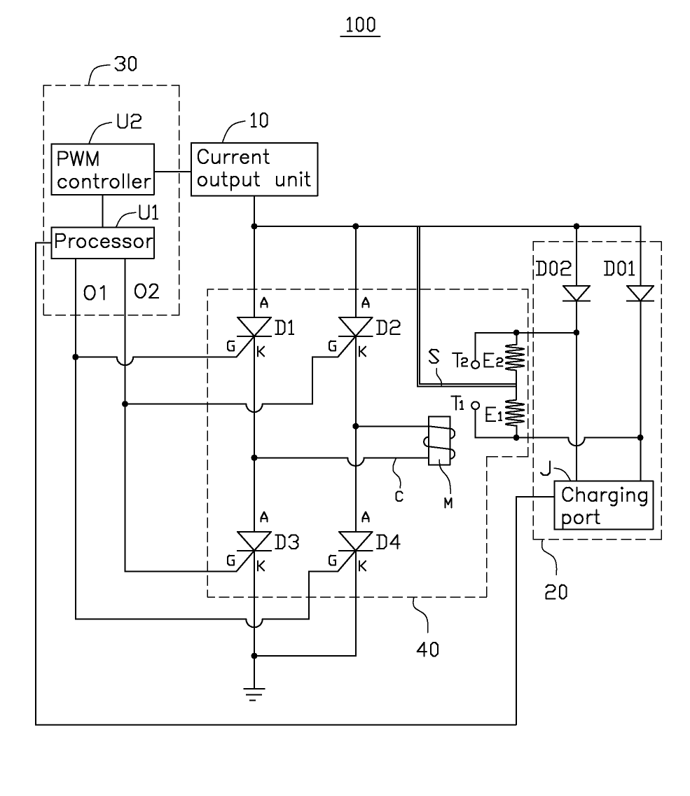

### FIELD

The subject matter herein generally relates to chargers, and particularly to a charger for a portable electronic device.

### BACKGROUND

When power of an electronic device (e.g. a mobile phone or tablet computer) is exhausted, a charger may recharge the electronic device.

### BRIEF DESCRIPTION OF THE DRAWINGS

Implementations of the present technology will now be described, by way of example only, with reference to the attached figure, wherein:

The figure is a circuit view of one embodiment of a charger.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an EPROM. The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

The present disclosure is described in relation to a charger.

The figure is circuit view of one embodiment of a charger 100. The charger 100 is configured to charge a first device and a second device. In one embodiment, the first device can be a mobile phone, and a second device can be a tablet computer.

The charger 100 includes a current output unit 10, an identification unit 20, a control unit 30, and a switching unit 40.

The current output unit 10 is configured to output current. Specifically, the current output unit 10 outputs an initial current before the first device and the second device are identified. Additionally, the current output unit 10 outputs a first charging current or a second charging current according to the one of the first device and the second device which is identified by the identification unit 20.

The identification unit 20 is configured to identify which one of the first device and the second device is electrically connected thereto, and output identification signals accordingly. The identification unit 20 includes a charging port J, a first diode D01, and a second diode D02. The first device or the second device can be coupled to the charging port J for obtaining current from the charger 100. An anode of the first diode D01 is coupled to the current output unit 10, and a cathode of first diode D01 is coupled to the charging port J. An anode of the second diode D02 is coupled to the current output unit 10, and a cathode of second diode D02 is coupled to the charging port J.

Generally, an impedance of the first device is different from an impedance of the second device. When the first device is coupled to the charging port J, the charging port J triggers a first voltage drop signal corresponding to the impedance of the first device. When the second device is coupled to the charging port J, the charging port J triggers a second voltage drop signal corresponding to the impedance of the second device.

The control unit 30 is coupled to the current output unit 10, the identification unit 20, and the switching unit 40. The control unit 30 is configured to control the current output unit 10 and the switching unit 40 based on the first voltage drop signal and the second voltage drop signal. The control unit 30 includes a processor U1 and a pulse width modulation (PWM) controller U2 coupled to the processor U1 and the current output unit 10. The processor U1 is coupled to the charging port J to receive the first voltage drop signal and the second voltage drop signal. When the first voltage drop signal is received, the processor U1 outputs a first command to the PWM controller U2, and then the PWM controller U2 controls the current output unit 10 to output the first charging current. When the second voltage drop signal is received, the processor U1 outputs a second command to the PWM controller U2, and then the PWM controller U2 controls the current output unit 10 to output second first charging current.

The processor U1 includes a first output pin 01 and a second output pin 02. The first output pin 01 is coupled to the switching unit 40, to output a first control signal to the switching unit 40 according to the first voltage drop signal. The second output pin 02 is coupled to the switching unit 40, to output a second control signal to the switching unit 40 according to the second voltage drop signal.

The switching unit 40 is directed by the processor U1 to provide a first charging path and a second charging path between the current output unit 10 and the charging port J. The switching unit 40 includes a first thyristor D1, a second thyristor D2, a third thyristor D3, a fourth thyristor D4, a magnet M, a coil C, an elastic sheet S, a first contact pin T1, a second contact pin T2, a first spring E1, and a second spring E2. The first thyristor D1 and the third thyristor D3 are electronically connected between the current output unit 10 and ground in series. The second thyristor D2 and the fourth thyristor D4 are electronically connected between the current output unit 10 and ground in series, and are jointly parallel to the first thyristor D1 and the third thyristor D3. Each of the first thyristor D1, the second thyristor D2, the third thyristor D3, and the fourth thyristor D4 includes an anode A, a cathode K, and a gate G. The gates G of the first thyristor D1 and the fourth thyristor D4 are electronically connected to the first output pin O1. Thus, the first thyristor D1 and the fourth thyristor D4 can be turned on by the first control signal output from the first output pin O1. The gates G of the second thyristor D2 and the third thyristor D3 are electronically connected to the second output pin O2. Thus, the second thyristor D2 and the third thyristor D3 can be turned on by the second control signal output from the second output pin O2.

The coil C is coiled on the magnet M. A first end of the coil C is electronically connected between the cathode K of the first thyristor D1 and the anode A of the third thyristor D3, and a second end of the coil C is electronically connected between the cathode K of the second thyristor D2 and the anode A of the fourth thyristor D4. The first contact pin T1 is electronically connected between the cathode of the first diode D01 and the charging port J, and the second contact pin T2 is electronically connected between the cathode of the second diode D02 and the charging port J. The elastic sheet S is substantially an L-shaped magnetic sheet, a first end of the elastic sheet S is electronically connected to the current output unit 10, and a second end of the elastic sheet S is adjacent to the magnet M, and is positioned between the first contact pin T1 and the second contact pin T2.

The first spring E1 and the second spring E2 are positioned opposite to each other. The first spring E1 is mechanically coupled to the first contact pin T1 and the charging port J, and is coupled to the elastic sheet S via an insulation wire. The second spring E2 is mechanically coupled to the second contact pin T2 and the charging port J, and is coupled to the elastic sheet S via an insulation wire. Thus, the elastic sheet S can be steadily positioned between the first contact pin T1 and the second contact pin T through the first spring E1 and the second E2. In other embodiments, the elastic sheet S can be positioned by other mechanisms, and thus the first spring E1 and the second spring E2 can be omitted.

In use, when the first device or the second device is coupled to the charging port J, the current output unit 10 outputs the initial current to instantaneously charge the first device or the second device.

If the first device is identified, the charging port J triggers the first voltage drop signal. The processor U1 receives the first voltage drop signal, and accordingly outputs a first command to the PWM controller U2. Thus, the PWM controller U2 controls the current output unit 10 to output the first charging current. In addition, the first output pin O1 outputs the first control signal to turn on the first thyristor D1 and the fourth thyristor D4, and then the coil C receives the first charging current via the first thyristor D1 and the fourth thyristor D4. In this embodiment, a winding direction of the coil C relative to the magnet M to allow the magnet M to attract the elastic sheet S. Thus, the elastic sheet S contacts the first contact pin T1. Therefore, the current output unit 10, the elastic sheet S, the first contact pin T1, and the charging port J form the first current path to allow the first device to obtain the first charging current form the current output unit 10.

If the second device is identified, the charging port J triggers the second voltage drop signal. The processor U1 receives the second voltage drop signal, and accordingly outputs a second command to the PWM controller U2. Thus, the PWM controller U2 controls the current output unit 10 to output the second charging current. In addition, the second output pin O2 outputs the second control signal to turn on the second thyristor D2 and the third thyristor D3, and then the coil C receives the second charging current via the second thyristor D2 and the third thyristor D3. In this embodiment, a winding direction of the coil C relative to the magnet M to allow the magnet M to repel the elastic sheet S. Thus, the elastic sheet S contacts the second contact pin T2. Therefore, the current output unit 10, the elastic sheet S, the first contact pin T1, and the charging port J form the second current path to allow the second device to obtain the second charging current form the current output unit 10.

When no device is coupled to the charging port J, the first thyristor D1, the second thyristor D2, the third thyristor D3, and the fourth thyristor D4 are turned off by the control unit 30. Thus, the coil C cannot receive current, and the elastic sheet S contacts neither the first contact pin T1 nor the second contact pin T2.

In summary, the identification unit identifies the first device and the second device, and respectively provides a first voltage drop signal and a second voltage drop signal to the control unit 30. The control unit 30 controls the current output unit 10 to output the first charging current and the second charging current, and also controls the switching unit 40 to establish the first current path and the second path. Thus, the first device can obtain the first charging current from the first current path, and the second device can obtain the second charging current from the second current path. Since the charger 100 can be compatible with the first device and the second device, thus, the charger 100 is both convenient and efficient.

The embodiments shown and described above are only examples. Many details are often found in the art such as the other features of a charger. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A charger or charging a first device and a second device, the charger comprising:
a current output unit;
a switching unit;
an identification unit identifying one of the first device and the second device, and triggering a first voltage drop signal corresponding to the first device and a second voltage drop signal corresponding to the second device; and
a control unit coupled to the current output unit, the switching unit, and the identification unit;
wherein the control unit controls the current output unit to output a first charging current according to the first voltage drop signal, and controls the switching unit to establish a first current path between the current output unit and the first device; and
wherein the control unit controls the current output unit to output a second charging current according to the second voltage drop signal, and controls the switching unit to establish a second current path between the current output unit and the second device.

2. The charger as claimed in claim 1, wherein the identification unit comprises a charging port, a first diode, and a second diode, the charging port is configured to be coupled to the first device or the second device, an anode of the first diode is coupled to the current output unit, and a cathode of first diode is coupled to the charging port, an anode of the second diode is coupled to the current output unit, and a cathode of second diode is coupled to the charging port.

3. The charger as claimed in claim 2, wherein the control unit comprises a processor and a pulse width modulation (PWM) controller coupled to the processor, the processor is coupled to the charging port to receive the first voltage drop signal and the second voltage drop signal, the processor outputs a first command to the PWM controller when the first voltage drop signal is received, and outputs a second command to the PWM controller when the second voltage drop signal is received.

4. The charger as claimed in claim 3, wherein the PWM controller is coupled to the current output unit, the PWM controller controls the current output unit to output the first charging current according to the first command, and controls the current output unit to output the second charging current according to the second command.

5. The charger as claimed in claim 3, wherein the processor comprises a first output pin and a second output pin, the first output pin is coupled to the switching unit to output a first control signal to the switching unit according to the first voltage drop signal, the second output pin is coupled to the switching unit to output a second control signal to the switching unit according to the second voltage drop signal.

6. The charger as claimed in claim 5, wherein the switching unit comprises a first thyristor, a second thyristor, a third thyristor, and a fourth thyristor, the first thyristor and the third thyristor are electronically connected between the current output unit and ground in series, the second thyristor and the fourth thyristor are electronically connected between the current output unit and ground in series, and are jointly parallel to the first thyristor and the third thyristor, each of the first thyristor, the second thyristor, the third thyristor, and the fourth thyristor comprises a gate, the gates of the first thyristor and the fourth thyristor are electronically connected to the first output pin, and the gates of the second thyristor and the third thyristor are electronically connected to the second output pin.

7. The charger as claimed in claim 6, wherein the switching unit further comprises a magnet and a coil, the coil is coiled on the magnet, a first end of the coil is electronically connected between the first thyristor and the third thyristor, and a second end of the coil is electronically connected between the second thyristor and the fourth thyristor.

8. The charger as claimed in claim 7, wherein the switching unit further comprises a first contact pin, a second contact pin, and an elastic sheet, the first contact pin is electronically connected between the cathode of the first diode and the charging port, and the second contact pin is electronically connected between the cathode of the second diode and the charging port, a first end of the elastic sheet is electronically connected to the current output unit, and a second end of the elastic sheet is adjacent to the magnet, and is positioned between the first contact pin and the second contact pin.

9. The charger as claimed in claim 8, wherein the switching unit further comprises a first spring and a second spring, the first spring is mechanically coupled to the first contact pin and the charging port, and is coupled to the elastic sheet via an insulation wire, the second spring is mechanically coupled to the second contact pin and the charging port, and is coupled to the elastic sheet via an insulation wire.

10. The charger as claimed in claim 8, wherein the current output unit, the elastic sheet, the first contact pin, and the charging port form the first current path, the current output unit, the elastic sheet, the second contact pin, and the charging port form the second current path.

11. A charger for charging a first device and a second device, the charger comprising:
a current output unit;
a switching unit;
an identification unit identifying the first device and the second device, and outputting identification signals accordingly;
a control unit coupled to the current output unit, the switching unit, and the identification unit; the control unit is configured to control the current output unit to output a first charging current or a second charging current according to the identification signals, and is configured to control the switching unit to establish a first current path or a second current path between the current output unit and the first device according to the identification signals.

12. The charger as claimed in claim 11, wherein the identification unit outputs a first voltage drop signal corresponding to the first device and a second voltage drop signal corresponding to the second device, the control unit controls the current output unit to output the first charging current according to the first voltage drop signal, and controls the switching unit to establish the first current path according to the first voltage drop signal, the control unit controls the current output unit to output the second charging current according to the second voltage drop signal, and controls the switching unit to establish the second current path according to the second voltage drop signal.

13. The charger as claimed in claim 12, wherein the identification unit comprises a charging port, a first diode, and a second diode, the charging port is configured to be coupled to the first device or the second device, an anode of the first diode is coupled to the current output unit, and a cathode of first diode is coupled to the charging port, an anode of the second diode is coupled to the current output unit, and a cathode of second diode is coupled to the charging port.

14. The charger as claimed in claim 13, wherein the control unit comprises a processor and a pulse width modulation (PWM) controller coupled to the processor, the processor is coupled to the charging port to receive the first voltage drop signal and the second voltage drop signal, the processor outputs a first command to the PWM controller when the first voltage drop signal is received, and outputs a second command to the PWM controller when the second voltage drop signal is received.

15. The charger as claimed in claim 14, wherein the PWM controller is coupled to the current output unit, the PWM controller controls the current output unit to output the first charging current according to the first command, and controls the current output unit to output the second charging current according to the second command.

16. The charger as claimed in claim 14, wherein the processor comprises a first output pin and a second output pin, the first output pin is coupled to the switching unit to output a first control signal to the switching unit according to the first voltage drop signal, the second output pin is coupled to the switching unit to output a second control signal to the switching unit according to the second voltage drop signal.

17. The charger as claimed in claim 16, wherein the switching unit comprises a first thyristor, a second thyristor, a third thyristor, and a fourth thyristor, the first thyristor and the third thyristor are electronically connected between the current output unit and ground in series, the second thyristor and the fourth thyristor are electronically connected between the current output unit and ground in series, and are jointly parallel to the first thyristor and the third thyristor, each of the first thyristor, the second thyristor, the third thyristor, and the fourth thyristor comprises a gate, the gates of the first thyristor and the fourth thyristor are electronically connected to the first output pin, and the gates of the second thyristor and the third thyristor are electronically connected to the second output pin.

18. The charger as claimed in claim 17, wherein the switching unit further comprises a magnet and a coil, the coil is coiled on the magnet, a first end of the coil is electronically connected between the first thyristor and the third thyristor, and a second end of the coil is electronically connected between the second thyristor and the fourth thyristor.

19. The charger as claimed in claim 18, wherein the switching unit further comprises a first contact pin, a second contact pin, and an elastic sheet, the first contact pin is electronically connected between the cathode of the first diode and the charging port, and the second contact pin is electronically connected between the cathode of the second diode and the charging port, a first end of the elastic sheet is electronically connected to the current output unit, and a second end of the elastic sheet is adjacent to the magnet, and is positioned between the first contact pin and the second contact pin.

20. The charger as claimed in claim 19, wherein the switching unit further comprises a first spring and a second spring, the first spring is mechanically coupled to the first contact pin and the charging port, and is coupled to the elastic sheet via an insulation wire, the second spring is mechanically coupled to the second contact pin and the charging port, and is coupled to the elastic sheet via an insulation wire.
